(19) United States
(12) Patent Application Publication
(10) Pub. No.: US 2025/0119505 A1
(43) Pub. Date: Apr. 10, 2025

(54) COMPUTER-READABLE MEDIUM AND CONTROL METHOD

(71) Applicant: CANON KABUSHIKI KAISHA, Tokyo (JP)

(72) Inventor: HIROYOSHI IWAYAMA, Kanagawa (JP)

(21) Appl. No.: 18/903,091

(22) Filed: Oct. 1, 2024

(30) Foreign Application Priority Data
Oct. 5, 2023 (JP) 2023-173860

(51) Int. Cl. H04N 1/00

(52) U.S. Cl. CPC H04N 1/00952; H04N 1/00464; H04N 1/00938

(57) ABSTRACT

A method of controlling a first apparatus and a second apparatus is provided. The first apparatus has a first operating environment that is on a host OS, but is not on a guest OS, and the second apparatus has a second operating environment that is on the guest OS. In the first apparatus, a program receives an operation from a user, and displays a first screen containing a button for displaying a screen by using another program based on a fact that the program operates in the first operating environment and a fact that the program has received the operation. In the second apparatus, the program receives the operation from a user, and displays a second screen not containing the button based on a fact that the program operates in the second operating environment and a fact that the program has received the operation.

### BACKGROUND OF THE INVENTION

### Field of the Invention

The present invention relates to a computer-readable medium and a control method.

### Description of the Related Art

Conventionally, a user interface that displays a list of application programs is often used to start up an application program (hereinafter referred to as an “application”) from an information processing apparatus such as a mobile terminal. The user can select a desired application program from the list and execute it. Japanese Patent No. 4332525 describes a technique for determining whether or not a second application, which is directed to be executed in response to a first application being executed, is to be hidden with reference to configuration information regarding the second application, and not displaying the second application in the list if the second application is to be hidden.

According to Japanese Patent No. 4332525, whether to display or hide an application is determined based on configuration information regarding an application that is called by another application, and external factors are not used as the basis for the determination.

However, whether or not it is appropriate to allow execution of a program such as an application depends not only on the circumstances specific to the program, but also on external factors, such as the operating environment for the program.

### SUMMARY OF THE INVENTION

The present invention determines whether or not to allow a user to execute a program based on the operating environment for the program, and provides a user interface in accordance with the determination.

One aspect of the present invention provides a non-transitory computer-readable medium storing thereon a predetermined program operable on an operating system (OS), which when executed by one or more processors of a first information processing apparatus having a first operating environment on a first OS operating as a host OS but not on a guest OS, cause the first information processing apparatus to perform a first method, the first method comprising: receiving a predetermined operation from a user; and displaying a first screen containing a predetermined button for displaying a screen by using a program other than the predetermined program based on a fact that the predetermined program operates in the first operating environment and a fact that the predetermined program has received the predetermined operation, wherein the program, which when executed by one or more processors of a second information processing apparatus having a second operating environment on a second OS operating as the host OS and on the guest OS, cause the second information processing apparatus to perform a second method, the second method comprising: receiving the predetermined operation from a user; and displaying a second screen not containing the predetermined button based on a fact that the predetermined program operates in the second operating environment and a fact that the predetermined program has received the predetermined operation.

With the above configuration, it is possible to determine whether or not to allow a user to execute a program based on the operating environment for the program, and provide a user interface in accordance with the determination.

Further features of the present invention will become apparent from the following description of exemplary embodiments with reference to the attached drawings.

### BRIEF DESCRIPTION OF THE DRAWINGS

FIG. 1 is a diagram showing an example of a configuration of a communication system.

FIGS. 2A and 2B are diagrams showing a software configuration of an information processing apparatus.

FIG. 3 is a diagram showing a software configuration of a print application.

FIG. 4 is a flowchart a procedure performed when photo printing is selected in the print application.

FIGS. 5A, 5B, and 5C are diagrams showing examples of display screens of an information processing apparatus.

FIG. 6 is a flowchart showing a procedure performed when another application is selected from the print application.

FIG. 7 is a flowchart showing a procedure performed when another application is selected from the print application.

FIGS. 8A and 8B are diagrams showing examples of display screens of an information processing apparatus.

FIGS. 9A and 9B are flowcharts showing a procedure performed when another application is selected from a print application according to a second embodiment.

FIGS. 10A and 10B are flowcharts showing a procedure performed when another application is selected from the print application according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Furthermore, it should be understood that the scope of the present invention also includes any modifications and improvements to the embodiments described below that are made based on the ordinary knowledge of those skilled in the art, provided that the modifications and improvements do not deviate from the spirit of the present invention.

### First Embodiment

An information processing apparatus and a communication apparatus included in a communication system according to the present embodiment will be described below. In the present embodiment, a smartphone is illustrated as an example of the information processing apparatus, but the information processing apparatus is not limited to it, and various apparatuses such as a mobile terminal, a laptop PC, a tablet terminal, a PDA (Personal Digital Assistant), a digital camera, and so on may be adopted. In addition, various types of communication apparatuses can be adopted as long as they are capable of performing wireless communication with the information processing apparatus. For example, in the case of printers, inkjet printers, full-color laser beam printers, monochrome printers, and so on can be adopted. In addition to printers, scanners, copiers, facsimile machines, mobile terminals, smartphones, laptop PCs, tablet terminals, PDAs, digital cameras, music playback devices, televisions, smart speakers, and so on can also be adopted. Furthermore, multifunction machines equipped with a plurality of functions such as a copying function, a fax function, a printing function, a scanning function, and so on can also be adopted. In the present embodiment, the communication apparatus is a multifunction printer equipped with a printing function, a scanner function, and so on.

### Hardware Configurations of Apparatuses

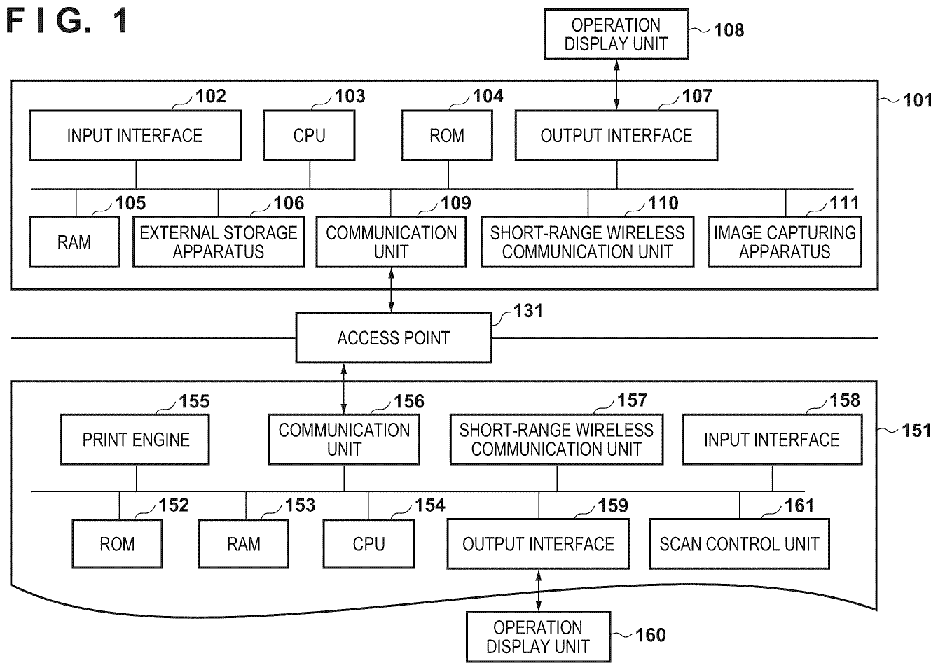

First, the configurations of an information processing apparatus included in the communication system according to the present embodiment and a communication apparatus capable of communicating with the information processing apparatus will be described with reference to the block diagram in FIG. 1. In the present embodiment, the following configurations will be described as examples, but the functions are not particularly limited to those shown in this figure.

An information processing apparatus 101 includes an input interface 102, a CPU 103, a ROM 104, a RAM 105, an external storage apparatus 106, an output interface 107, an operation display unit 108, a communication unit 109, a short-range wireless communication unit 110, an image capturing apparatus 111, and so on.

The input interface 102 is an interface used to receive data input and operational instructions from a user, and includes a physical keyboard, buttons, a touch panel, and so on.

Note that the output interface 107 and the input interface 102, which will be described later, may have the same configuration, so that the output of screens and the reception of user operations are performed using the same configuration.

The CPU 103 is a system control unit, and controls the entire information processing apparatus 101.

The ROM 104 stores fixed data such as control programs to be executed by the CPU 103, data tables, and built-in operating system (hereinafter referred to as OS) programs. In the present embodiment, each control program stored in the ROM 104 performs software execution control such as scheduling, task switching, and interrupt processing under the management of the built-in OS stored in the ROM 104. Note that, in the present embodiment, the OS stored in the ROM 104 and operating on the information processing apparatus 101 is the Android (registered trademark) OS provided by Google Inc. or the Chrome (registered trademark) OS provided by Google Inc. When the OS operating on the information processing apparatus 101 is the Chrome OS, the ROM 104 also stores a virtual Android OS for operating applications for the Android OS, which will be described later, on the information processing apparatus 101.

The RAM 105 is constituted by a static random access memory (SRAM) or the like that requires a backup power supply. Note that the RAM 105 retains data using a primary battery (not shown) for data backup, so that important data such as program control variables can be stored without volatilization. In addition, the RAM 105 also includes a memory area for storing setting information for the information processing apparatus 101, management data for the information processing apparatus 101, and so on. The RAM 105 is also used as a main memory and a work memory for the CPU 103.

The external storage apparatus 106 includes an application program (hereinafter referred to as a communication application) having the function of communicating with a communication apparatus 151. Specifically, the communication application is an application having, for example, a printing function that enables the communication apparatus 151 to perform printing, and a scanning function that enables the communication apparatus 151 to perform scanning. However, the present invention is not limited to this form, and may be an application having either a printing function or a scanning function, or may be an application having other functions. The external storage apparatus 106 stores various programs such as a print information generation program for generating print information that can be interpreted by the communication apparatus 151, and an information transmission/reception control program for transmitting and receiving information to and from the communication apparatus 151 connected via the communication unit 109. The external storage apparatus 106 stores various kinds of information used by these programs. The external storage apparatus 106 also stores image data acquired from other information processing apparatus or the Internet via the communication unit. In the present embodiment, the communication application is an application for the Android OS.

The output interface 107 is an interface that performs control to enable the operation display unit 108 to display data and provide a notification regarding the status of the information processing apparatus 101.

The operation display unit 108 is constituted by a light emitting diode (LED), a liquid crystal display (LCD), and so on, and displays data and provides a notification regarding the status of the information processing apparatus 101. Note that a software keyboard including keys such as numeric input keys, mode setting keys, an enter key, a cancel key, and a power key may be provided on the operation display unit 108 so that input from the user can be received via the operation display unit 108.

The communication unit 109 is a component for connecting to apparatuses such as the communication apparatus 151 and performing data communication. For example, the communication unit 109 is capable of connecting to an access point (not shown) in the communication apparatus 151. The connection between the communication unit 109 and the access point in the communication apparatus 151 enables the information processing apparatus 101 and the communication apparatus 151 to communicate with each other. In the following description, the access point may also be referred to as an AP. The communication unit 109 may also communicate directly with the communication apparatus 151 through wireless communication, or may communicate via an access point 131 that is present outside the information processing apparatus 101 and outside the communication apparatus 151. The wireless communication method used in the present embodiment conforms to the IEEE 802.11 series communication standard. Note that the IEEE 802.11 series communication standard is specifically Wi-Fi (registered trademark).

The access point 131 is, for example, a device such as a wireless LAN router. In the present embodiment, a method in which the information processing apparatus 101 and the communication apparatus 151 are directly connected to each other without an external access point being interposed therebetween is referred to as a direct connection method. A method in which the information processing apparatus 101 and the communication apparatus 151 are connected via the external access point 131 is referred to as an infrastructure connection method.

The short-range wireless communication unit 110 is a component for wirelessly connecting to apparatuses such as the communication apparatus 151 at short distances and performing data communication, and performs communication using a different communication method than the communication unit 109. The short-range wireless communication method used by the short-range wireless communication unit 110 is, for example, Bluetooth (registered trademark) or near field communication (NFC). The Bluetooth may be Bluetooth Classic or Bluetooth Low Energy. The short-range wireless communication unit 110 is capable of connecting to a short-range wireless communication unit 157 included in the communication apparatus 151.

The image capturing apparatus 111 is an apparatus that converts an image captured by an image capturing element into digital data. The digital data is temporarily stored in the RAM 105. Thereafter, the digital data is converted into a predetermined image format by a program executed by the CPU 154 and stored in the external storage apparatus 106 as image data.

The ROM 152 stores fixed data such as control programs to be executed by the CPU 154, data tables, and OS programs.

The communication apparatus 151 includes a ROM 152, a RAM 153, a CPU 154, a print engine 155, a communication unit 156, the short-range wireless communication unit 157, an input interface 158, an output interface 159, an operation display unit 160, a scan control unit 161, and so on. A connection mode (communication mode) is set to the communication apparatus 151, and the communication apparatus 151 can operate in the connection mode that has been set.

The communication unit 156 is a component that enables the communication apparatus 151 to communicate with other apparatuses, and in the present embodiment, the communication unit 156 performs communication according to the IEEE 802.11 series communication standard. The communication unit 156 has, as an internal access point of the communication apparatus 151, an access point for connecting to apparatuses such as the information processing apparatus 101. Note that the access point can connect to the communication unit 109 of the information processing apparatus 101. Note that the communication unit 156 may communicate directly with the information processing apparatus 101 through wireless communication, or may communicate via the access point 131. The communication unit 156 may include hardware that functions as an access point, or operate as an access point by using software that enables the communication unit 156 to operate as an access point. In the present embodiment, the communication unit 156 and the short-range wireless communication unit 157 are realized using one wireless chip. That is to say, in the present embodiment, a combo chip that supports both the communication function of the IEEE 802.11 series communication standard and the communication function of the short-range wireless communication method is used. However, the present invention is not limited to this embodiment, and the communication unit 156 and the short-range wireless communication unit 157 may be realized using separate wireless chips.

The RAM 153 is constituted by a DRAM or the like that requires a backup power supply. The RAM 153 retains data using power from a power supply (not shown) for data backup, and therefore the RAM 153 can store important data such as program control variables without volatilizing. The RAM 153 is also used as a main memory and a work memory for the CPU 154, and serves as a reception buffer for temporarily storing print information received from the information processing apparatus 101 or the like, and stores various kinds of information.

The ROM 152 stores fixed data such as control programs to be executed by the CPU 154, data tables, and OS programs. In the present embodiment, each control program stored in the ROM 152 performs software execution control such as scheduling, task switching, and interrupt processing under the management of the built-in OS stored in the ROM 152. The ROM 152 also includes a memory area for storing data that needs to be retained even when power is not being supplied, such as setting information for the communication apparatus 151 and management data for the communication apparatus 151.

The CPU 154 is a system control unit, and controls the entire communication apparatus 151.

The print engine 155 forms an image on a recording medium such as paper using a recording agent such as ink, based on information stored in the RAM 153 or a print job received from the information processing apparatus 101 or the like, and outputs the print result. At this time, the print job transmitted from the information processing apparatus 101 or the like has a large amount of transmission data and requires high-speed communication. Therefore, the print job is received via the communication unit 156, which is capable of performing communication at a higher speed than the short-range wireless communication unit 157.

The short-range wireless communication unit 157 is a component for wirelessly connecting to apparatuses such as the information processing apparatus 101 at short distances and performing data communication, and performs communication using a different communication method than the communication unit 156. The short-range wireless communication method used by the short-range wireless communication unit 110 is, for example, Bluetooth (registered trademark) or NFC. The Bluetooth may be Bluetooth Classic or Bluetooth Low Energy. The short-range wireless communication unit 157 can connect to the short-range wireless communication unit 110.

The input interface 158 is an interface used to receive data input and operational instructions from a user, and includes a physical keyboard, buttons, a touch panel, and so on. Note that the output interface 159, which will be described later, and the input interface 158 may have the same configuration, so that the output of screens and the reception of user operations are performed using the same configuration. The output interface 159 is an interface that performs control to enable the operation display unit 160 to display data and provide a notification regarding the status of the communication apparatus 151.

The operation display unit 160 is constituted by display units such as a light emitting diode (LED) and a liquid crystal display (LCD), and displays data and provides a notification regarding the status of the communication apparatus 151. Note that a software keyboard including keys such as numeric input keys, mode setting keys, an enter key, a cancel key, and a power key may be provided on the operation display unit 160 so that input from the user can be received via the operation display unit 160.

The scan control unit 161 includes an image sensor unit (reading unit) that scans an original placed on a platen or ADF (not shown). Note that the image sensor unit includes a light source that irradiates light onto an original and an image sensor in which elements that read the reflected light from the original and perform photoelectric conversion arranged. The scan control unit 161 acquires image data by performing analog-to-digital (A/D) conversion on an analog electrical signal acquired by reading an original with the image sensor unit. The scan control unit 161 also includes a circuit for performing direct memory access (DMA) transfer to store the acquired image data in the RAM 153.

### Software Configuration of Information Processing Apparatus 101

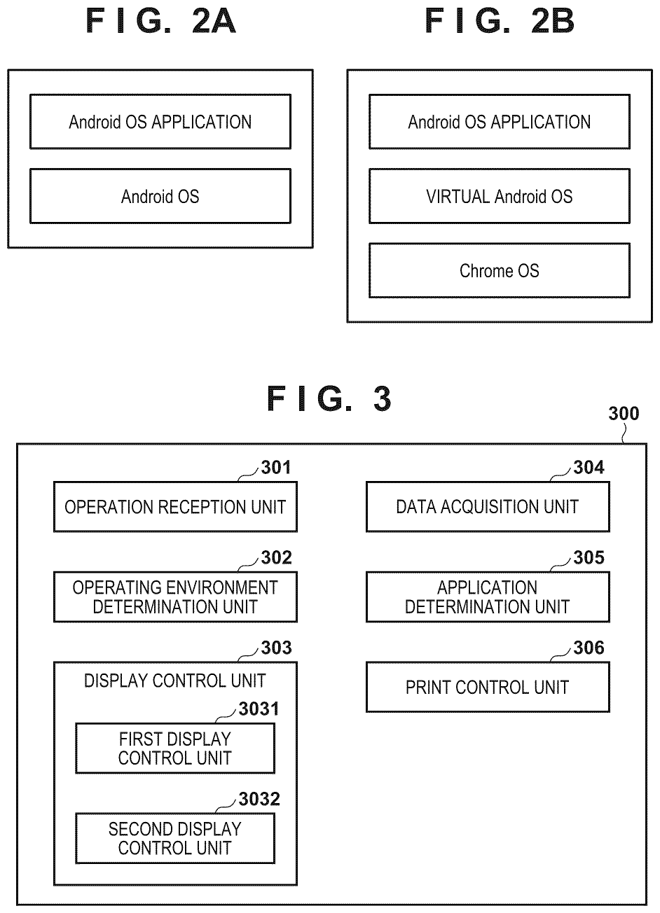

Next, the software configuration of the information processing apparatus 101 according to the present embodiment will be described. FIG. 2A shows an example of the software configuration of the information processing apparatus 101 when the host OS operating on the information processing apparatus 101 is the Android OS. In this form, applications for the Android OS operate on the Android OS. In this form, the software configuration of the information processing apparatus 101 does not include the Chrome OS. As in this form, an environment in which the OS operating at the lowest layer of the information processing apparatus 101 is the Android OS (not the Chrome OS) is hereinafter referred to as a first environment (also referred to as a first operating environment or a real environment). A specific example of the first environment is an environment in which the information processing apparatus 101 is equipped with a host OS but not with a guest OS, and a communication application operates on the host OS. Another specific example of the first environment is an environment in which the information processing apparatus 101 is equipped with both a host OS and a guest OS, and a communication application operates on the host OS without intervention of the guest OS (does not operate on the guest OS). Note that the host OS is the host operating system, and the guest OS is the guest operating system.

FIG. 2B shows an example of the software configuration of the information processing apparatus 101 when the host OS operating on the information processing apparatus 101 is the Chrome OS. In this form, a virtual Android OS, which is a virtual OS, operates on the Chrome OS. Applications for the Android OS operate on the virtual Android OS. As in this form, an environment in which the OS operating at the lowest layer of the information processing apparatus 101 is the Chrome OS, and the virtual Android OS operates on the Chrome OS is hereinafter referred to as a second environment (also referred to as a second operating environment or a virtual environment). In the present embodiment, the virtual OS is a program for operating an application that is not compatible with the host OS on the host OS and is a guest OS. Note that the virtual OS may be the entirety of an existing OS such as the Android OS, or the entirety of an existing OS with some modules omitted, or a program created separately from an existing OS. The virtual OS is realized using a virtualization technology such as the Virtual Machine method or the container method.

The virtual Android OS may also be realized by an emulator that leaves functions such as a resource management function to the Chrome OS and provides an execution environment for Android applications. In this case, the emulator itself is not an OS, but provides the virtual Android OS, i.e. the second environment, including the Chrome OS.

The issues that arise when operating an Android OS application in the second environment will be described below. As an example, a case in which the above-mentioned communication application is installed and executed in both the first environment and the second environment will be described. The communication application may also be referred to as a print application because it has the function of communicating with the communication apparatus 151, which has a printing function, to print images or the like. In addition, application programs developed in accordance with the Android OS to operate on the Android OS may also referred to as Android applications.

The communication application, which is an Android application in the present embodiment, provides the function of printing images (hereinafter referred to as photo printing), and when the photo printing function is selected, icons of pieces of image data stored in a predetermined folder are displayed on an image list screen (a selection screen 1 or a selection screen 3 described below). A piece of mage data selected from the list can be transmitted to the communication apparatus 151 and printed. The icon of each piece of image data may be a specific icon corresponding to the piece of image data, or a piece of image data of a reduced image obtained by reducing the piece of image data.

In the present embodiment, the communication application can start up an application other than the communication application and display a screen by using the application other than the communication application. Specifically, the communication application displays a cloud linkage icon (a cloud linkage button) used to select the cloud linkage function on the image list screen. The cloud linkage function is a function that enables the information processing apparatus 101 to print image data provided by a cloud server (not shown) on the Internet that is connected to the information processing apparatus 101 via the communication unit 109. When the cloud linkage icon is selected, for example, by a tap operation, a web browser (a browser program), which is one of the Android applications, is started up, and a screen (a selection screen 2, which will be described below) displaying a list of pieces of image data provided by the cloud server is displayed by the web browser. The user can select a desired image from the displayed list, download the image, and print the image from the communication apparatus 151. Note that the services provided by the cloud server are referred to as cloud services. In the information processing apparatus 101, the screens displayed by the applications are respectively displayed in separate windows. However, the present invention is not limited to this form, and screens displayed by a plurality of applications may be displayed in a layered manner in one window. However, in the present embodiment, at least the image list screen displayed by the communication application and the screen displayed by the web browser are displayed in separate windows.

Here, the first environment, i.e. the Android OS, performs single-window control, and only one window is displayed at a time. Therefore, when a window corresponding to the web browser is displayed, the window corresponding to the communication application is no longer displayed. That is to say, when a browser screen is displayed, the screen overwrites the previous screen, i.e. the image list screen. Therefore, in this state, the user cannot operate the previous image list screen, and the browser screen is the subject of operation. For example, when a piece of image data is selected on the browser screen and downloaded, the browser screen is closed and the image list screen is displayed again, allowing the user to perform operations on that screen.

In contrast, the second environment, i.e. the virtual Android OS built on the Chrome OS, performs multi-window control, and in the second environment, the information processing apparatus 101 can display a plurality of windows simultaneously. That is to say, when the communication application starts up a web browser, a window corresponding to the communication application and a window corresponding to the web browser are displayed at the same time. Therefore, even when the pieces of image data in the cloud server are displayed in a list in the window corresponding to the web browser, the user can still operate the image list screen in the window corresponding to the communication application. For example, while the list of pieces of image data provided by the cloud linkage function is still displayed, the user can also cancel the photo printing function or return to the home screen of the communication application to select and execute a function other than the photo printing function. In this way, unexpected operations that are not anticipated in the first environment, which is the original operating environment for the communication application, become possible in the second environment. This not only confuses the user and reduces operability, but can also lead to unexpected results.

In addition, when the browser is started up using the cloud linkage function, if the user selects data (file) from the list displayed on the browser screen, the selected data is downloaded and passed to the communication application in a predetermined format. Since the downloaded data is handed over via the OS, the format of the data handed over may differ depending on the OS, for example, it may differ between the Android OS and the Chrome OS. In the virtual Android OS environment (the second environment) that is based on the Chrome OS, the communication application receives data in the Chrome OS format, not the Android OS format that the communication application expects. Therefore, the communication application cannot process the received data as is. For example, even if the communication application tries to print the data, it will not be able to print the data.

The communication application can also display a buttons (an icon) used to call Android applications other than the web browser. In the communication application, the communication apparatus used for printing is registered in advance, a list of functions (a list of icons) that can be executed on the registered communication apparatus is displayed, and a function selected from the list can be executed. If the application that executes the function selected at this time is not yet installed, an installation screen is displayed. If the application is already installed, the application is started up.

The Android application selected and started up from the communication application may not necessarily be installable in the second environment. This is because the second environment is not necessarily fully compatible with the first environment, but is only partially compatible (has limited compatibility). As a result, the selected app may not be installable, or even if it is installed, it may not operate properly. It can be said that the two problems mentioned above are also due to this limited compatibility. However, the two issues mentioned above are due to incomplete compatibility of the operations of the application and the data format, even though the application has been successfully installed in the second environment and operates properly. The third problem arises when the compatibility of the second environment with the first environment is so limited that a particular application cannot be installed in the second environment or the application can be installed but cannot operate properly.

These problems can also be solved by the vendor of the OS that provides the second environment providing the second environment with higher compatibility with the first environment. However, this method is not available to application vendors. In order to solve the above problems from the application side, an application that is compatible with a plurality of operating environments is provided. A communication application according to the present embodiment will be described below as an example of such an application.

### Configuration of Communication Application

FIG. 3 shows the configuration of the communication application stored in the ROM 104, the external storage apparatus 106, or the like of the information processing apparatus 101. The communication application is an application program that can operate on an OS and has a printing function for enabling the communication apparatus 151, which functions as a printer or a printing apparatus, to print image data, document data, or the like stored in the information processing apparatus 101. The communication application also has the function of, for example, importing image data, document data, or the like scanned by the communication apparatus 151 into the information processing apparatus 101.

A communication application 300 includes an operation reception unit 301, an operating environment determination unit 302, a display control unit 303, an image data acquisition unit 304, an application determination unit 305, and a print control unit 306. Each program module is executed by the CPU 103 and realizes the function thereof. In the present embodiment, the communication application 300 receives operations performed on the operation display unit 108 via the operation reception unit 301. The operating environment determination unit 302 determines whether the current operating environment for the communication application 300 is the first environment provided by the Android OS or the second environment provided by the virtual Android OS built on the Chrome OS. This determination can be made based on a response to querying the OS, or by reference to a predetermined memory location.

The display control unit 303 controls the display on the operation display unit 108 by the communication application 300. In particular, the display control unit 303 changes the display depending on whether the current environment in which the communication application 300 is operating is the first environment or the second environment, and a first display control unit 3031 performs display control in the first environment and a second display control unit 3032 performs display control in the second environment. In addition, the display control unit 303 controls the screen to be displayed based on the determination by the application determination unit 305 as to whether or not the application can be started up from the communication application 300. For example, the display control unit 303 displays the icons of applications that can be started up from the communication application 300, and hide the icons of applications that cannot be started up.

The image data acquisition unit 304 acquires document data, image data, or the like from a data source such as a cloud server. The acquired data is transmitted to the communication apparatus 151 and printed under the control of the print control unit 306, or is stored in the external storage apparatus 106 or the like of the information processing apparatus 101.

The application determination unit 305 determines whether or not an application can be started up, for example, with respect to an Android application installed in the environment, or an application whose icon, which is used to start up the application from the communication application 300, is contained in the screen of the communication application 300. The determination is also based on the results of the determination regarding the operating environment by the operating environment determination unit 302, and may also be based on the functions of the communication apparatus 151 or whether or not the device used by the application is available in the current environment.

The print control unit 306 transmits the selected data to be printed to the selected communication apparatus 151 for printing. The data to be printed may be, for example, document data, image data, or the like that is stored when the communication application 300 is started up. The data may also be data acquired from a cloud server, the communication apparatus 151, or the like. The data may also be data acquired from another data source. Hereinafter, it is assumed that the processing described as being performed by the components shown in FIG. 3 and included in the communication application is, more precisely, processing that is realized by the CPU 103 reading the communication application stored in the ROM 104 or the like into the RAM 105 and executing the application.

### Communication Application Startup Processing

The communication application 300 installed in the information processing apparatus 101 is displayed as an icon on the basic screen thereof, and is started up when the user performs a predetermined operation such as clicking on the icon. When the communication apparatus 151 to be used has not been selected, the communication application 300 thus started up first displays a list or the like of connectable communication apparatuses to allow the user to select one, and then saves the selected communication apparatus 151 as the selected communication apparatus. If the selected communication apparatus 151 has already been saved, there is no need to select it again. Thereafter, the name of the selected communication apparatus 151 and icons of functions that the user can use from the communication application 300 are displayed on the home screen of the communication application 300.

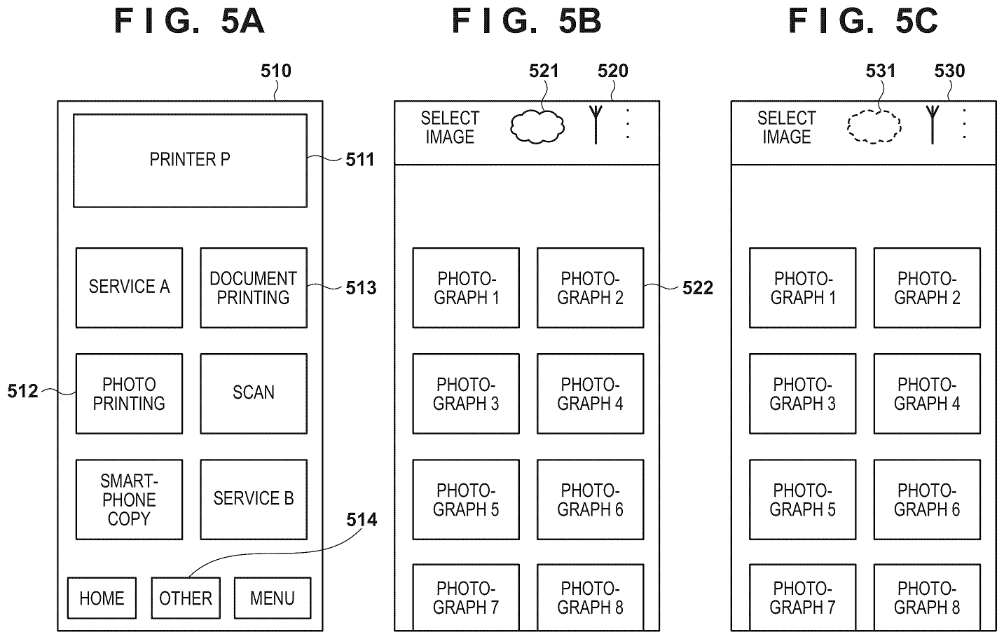

FIG. 5A is an example of a home screen 510. On the home screen 510, icons of various functions, such as an icon 511 of the selected communication apparatus, an icon (or button) 512 for photo printing, and an icon 513 for document printing, are displayed. Furthermore, an “Other” icon 514 used to display a menu for selecting another application is displayed. In the example in FIG. 5A, other icons displayed include a scan function icon for scanning an image using the communication apparatus 151 to acquire image data, and a smartphone copy icon for printing an image captured by the image capturing apparatus 111 of the information processing apparatus 101 using the communication apparatus 151. In addition, an icon used to end photo printing and return to the basic screen is also displayed. By selecting the icon 511 of the selected communication apparatus and performing an operation such as tapping, for example, the user can select the communication apparatus again. In addition, when the user selects and operates the icon of any of the various functions, processing for executing the function corresponding to the selected function icon is started. As a step of this processing, a window for the selected function may be displayed first.

### Photo Printing Function

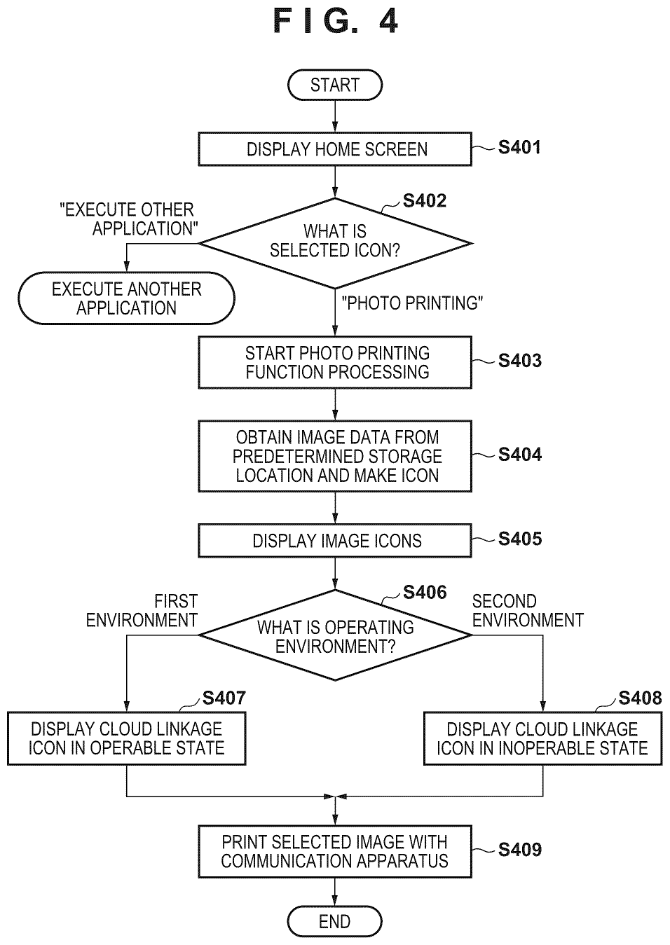

FIG. 4 shows an example of a procedure for displaying a screen when the communication application 300 is started up and the photo printing function is activated. The procedure in FIG. 4 is realized by the CPU 103 executing a program (communication application) stored in the RAM 105. This flowchart is executed upon the user performing an operation for starting up the communication application 300. An operation for starting up the communication application 300 is, for example, an operation performed on the icon corresponding to the communication application 300 displayed on the home screen displayed by a launcher of the information processing apparatus 101.

When the communication application 300 is started up, the CPU 103 displays the home screen 510 as shown in FIG. 5A in a window corresponding to the communication application 300 (S401). Here, when an icon on the home screen 510 is selected, the CPU 103 determines whether or not the selected icon is the icon 512 for the photo printing function (S402). If the selected icon is for photo printing, the CPU 103 starts processing to display a screen for the photo printing function in a window corresponding to the communication application 300 (S403). Furthermore, the CPU 103 acquires image data to be printed and forms an icon from the image data (S404). The image data from which an icon is formed is image data stored in a predetermined storage location such as the external storage apparatus 106, and is image data currently held in the memory of the information processing apparatus 101 itself or in a memory attached to the information processing apparatus 101. The CPU 103 displays one or more icons corresponding to the image data generated in step S404 in a window corresponding to the communication application 300 (S405). Thereafter, the CPU 103 receives an operation on the selection screen 1 from the user. Note that the selection of any icon on the selection screen 1 by the user is equivalent to the selection of image data corresponding to the selected icon.

Next, the CPU 103 determines the current operating environment (S406). This determination is performed by the operating environment determination unit 302 in terms of software, and the basis for this determination is as described for the operating environment determination unit 302. If it is determined that the current operating environment for the communication application 300 is the first environment (non-virtual environment) (i.e., the communication application 300 is operating on the host OS and not on the guest OS), the CPU 103 displays a cloud linkage icon in an operable state in the window corresponding to the communication application 300 (S407). As a result, the selection screen 1 shown in FIG. 5B is displayed in the window corresponding to the communication application 300. On the screen 520, which corresponds to the selection screen 1, image icons 522 are displayed in a selectable state, and a cloud linkage icon 521 is also displayed in an operable state. The operable state is a state in which the cloud linkage icon 521 can be selected by, for example, a tap operation or the like. When the cloud linkage icon 521 is selected, the communication application 300 starts up a web browser and displays a web page for cloud printing on the web browser. The web browser is an application program for displaying web pages, and is a different application from the communication application 300. When the web browser is started up, a screen corresponding to the web browser is displayed in a window separate from the window displaying the screen corresponding to communication application 300. Specifically, the web page for cloud printing is a screen used to select a cloud service to be used for cloud printing. Alternatively, the web page is, for example, the selection screen 2 that displays one or more icons corresponding to one or more pieces of image data provided by the selected cloud service. When the user selects an icon on the selection screen 2, the information processing apparatus 101 acquires image data corresponding to the selected icon from a cloud service via the Internet, using the communication application 300. The image data acquired here is printed in the processing described below. Here, the Android OS is operating in the first environment, and the information processing apparatus 101 does not display a plurality of windows simultaneously. That is to say, as a result of this processing, the web browser operates in the foreground, and the communication application 300 operates in the background. That is to say, the window of the web browser, which is started up when the cloud linkage icon 521 displayed on the screen 520 is selected, covers up the screen 520. In other words, as a result of this processing, only the window displaying the screen corresponding to the web browser is displayed, and the window displaying the screen corresponding to the communication application 300 is hidden. Therefore, the user cannot operate the screen 520 for photo printing.

On the other hand, if it is determined that the current operating environment for the communication application 300 is the second environment (virtual environment) (i.e. the communication application 300 is operating on a guest OS), the CPU 103 performs control to prevent the screen from being displayed in a window other than the window displaying the screen corresponding to the communication application 300 (S408). In the present embodiment, as described above, the cloud linkage icon is an icon used to start up a web browser, and the screen corresponding to the web browser is displayed in a window separate from the window displaying the screen corresponding to the communication application 300. Therefore, in this processing, the CPU 103 displays the cloud linkage icon in an inoperable state. As a result, the selection screen 3 shown in FIG. 5C is displayed in the window corresponding to the communication application 300. On a screen 530 corresponding to the selection screen 3, icons corresponding to pieces of image data are displayed in the same manner as on the screen 520.

On the other hand, a cloud linkage icon 531 is displayed in an inoperable state. In the example in FIG. 5C, the icon is displayed in gray in a non-selectable state. Therefore, the user cannot select the cloud linkage icon 521, and a new window corresponding to the web browser is not displayed. As mentioned above, in the second environment, a virtual Android OS is operating on the Chrome OS, and a plurality of windows can be displayed simultaneously. Therefore, by not displaying a new window corresponding to the web browser, it is possible to prevent (or restrict) a window corresponding to the web browser and a window corresponding to the communication application 300 from being displayed simultaneously (in parallel). This makes it possible to prevent an operation from being performed on the screen 530 for photo printing when, for example, a window corresponding to the web browser is displayed, such as when waiting for image selection. Note that steps S407 and S408 are performed by the first display control unit 3031 and the second display control unit 3032, respectively, in terms of software. The manner of display in an inoperable state, i.e. a state in which the icon cannot be operated, may include not displaying (i.e. hiding) the cloud linkage icon, or displaying the cloud linkage icon but graying it out. This processing may also be a control performed to display the cloud linkage icon in an operable state, but not to perform the processing of starting up the web browser (the processing of displaying a window corresponding to the web browser) even if the cloud linkage icon is operated. That is to say, in the present embodiment, when the current operating environment for the communication application 300 is the second environment (virtual environment), control is performed in this processing so that printing that is based on image data acquired by the communication application 300 via the Internet cannot be performed by the communication application 300. In other words, in the above-mentioned case, the communication application 300 is controlled so that it can only perform printing based on image data that is currently held in the memory of the information processing apparatus 101 itself or in a memory attached to the information processing apparatus 101 and is not image data acquired by the communication application 300 via the Internet.

Thereafter, the CPU 103 transmits image data corresponding to an icon selected from among the icons displayed on the selection screen 1 or the selection screen 2 to the communication apparatus 151 for printing (S409). Note that, using the cloud linkage function, image data corresponding to the icon selected from among the icons displayed on the web browser may be downloaded (acquired) by the communication application 300 via the Internet, and the icon may be displayed on the selection screen 1.

### Execution of Other Applications

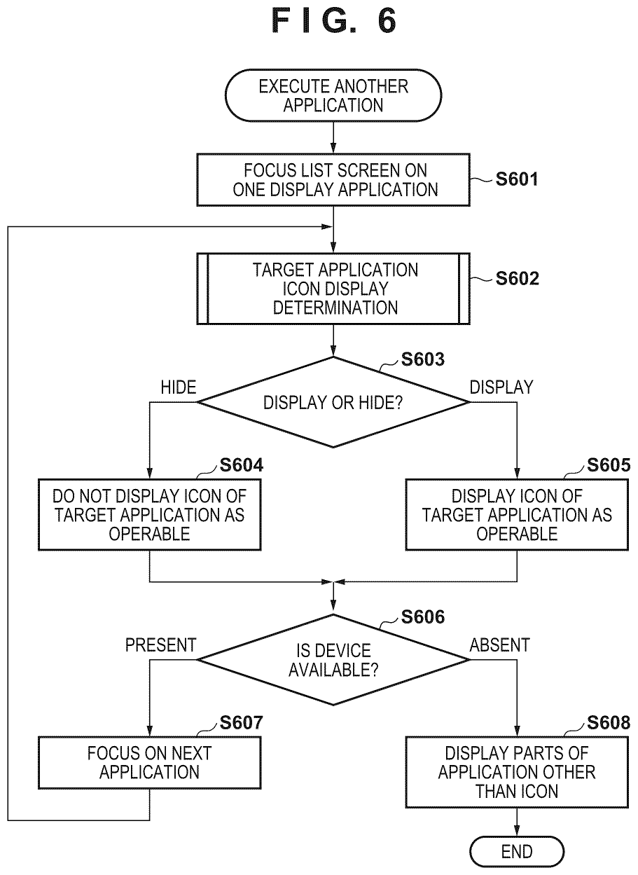

On the home screen 510 of the communication application 300, the user can select the “Other” icon 514 to display a list of icons of other Android applications, and execute the application selected from the list. FIG. 6 shows an example of processing performed when the “Other” icon 514 is selected and an application is selected from the list of applications displayed thereby. The processing in FIG. 6 is realized by the CPU 103 executing a program (communication application) stored in the RAM 105. Note that a list of installed applications and applications that have not been installed but are planned to be installed and used (also referred to as selection candidate applications) may be stored, for example, in the external storage apparatus 106 of the information processing apparatus 101. In addition, the icon of the application displayed as the “Other” icon may be an icon of an application provided by the same vendor (manufacturer) as the communication application 300.

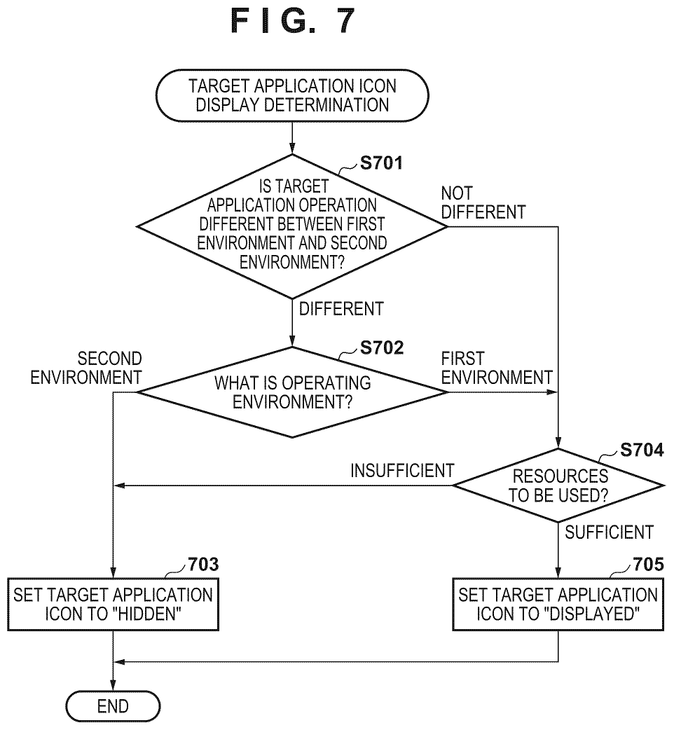

When the “Other” icon is selected, the CPU 103 first newly displays a screen corresponding to the “Other” icon in a window corresponding to the communication application 300, and focuses on one of the selection candidate applications (S601). The screen corresponding to the “Other” icon is a screen that displays a list of functions for starting up other applications, and is therefore hereinafter referred to as a “list screen”. The focused application is referred to as a “target application”. The CPU 103 determines whether or not to display the icon of the target application on the list screen (S602). The applications to be displayed are applications that can be executed in the second environment, and the applications not to be displayed are applications that cause inconvenience if executed in the second environment. This determination will be described with reference to FIG. 7. If it is determined in step S602 that the icon is to be hidden, the CPU 103 displays the list screen in a state in which the icon of the target application is non-selectable (S604). The manner of display in a non-selectable state may be to not display the icon. On the other hand, if it is determined in step S602 that the icon is to be displayed, the CPU 103 displays the list screen in a state in which the icon of the target application is selectable (S605).

Thereafter, the CPU 103 determines whether there is a next application in the selection candidate applications, i.e. whether there is an application that has not yet been targeted (S606). If there is such an application, the CPU 103 focuses on the next application and branches to step S602 (S607). If there is no such application, the CPU 103 displays necessary parts other than the application icon in the “Other” window (S608), and terminates processing. In this way, it is possible to display only the icons of applications that can be executed among the selection candidate applications, and to permit execution of those applications. Conversely, it is possible to restrict the execution of applications that are inconvenient to operate in the second environment by displaying their icons in an inoperable state.

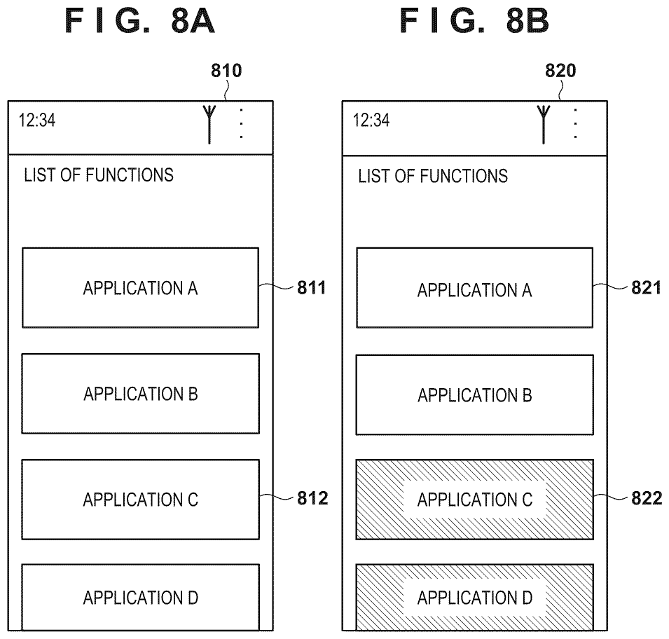

FIGS. 8A and 8B show examples of the list screen. FIG. 8A shows an example of a list screen 810 when it is determined in step S603 that all of applications A to D are to be displayed. In this example, both the application A 811 and the application C 812 are displayed in an operable state, and the user can select these icons to execute the corresponding applications. In contrast, FIG. 8B shows an example of a list screen 820 in which the applications C and D are displayed in gray and cannot be operated. In this example, an icon 821 of the application A can be operated, but an icon 822 of the application C cannot be operated and the application C cannot be started up. The same applies to the application D. In addition, in FIG. 8B, the icons of the applications C and D may be hidden.

FIG. 7 shows a typical procedure performed in step S602. The procedure is also performed by the CPU 103. First, the CPU 103 determines whether or not the operation of the target application is different between the first environment and the second environment (S701). Examples of cases where the operation is determined to be different include the case where the target application can operate normally in the first environment but cannot operate normally in the second environment, and the case where the target application does not operate as expected due to the operational difference between the first and second environments. The examples may also include the case where the operation of the target application is guaranteed in the first environment, but not guaranteed in the second environment. A specific example of the basis for the determination in step S701 may be the type of the target application. For example, if the application uses the image capturing apparatus 111, such as a camera, to capture an image, when the photographing button is operated after the application is started up, the application displays the captured image and saves the image in response to a confirmation operation by the user. Such an application operates regardless of the operating environment, and can be used as long as the image capturing apparatus 111 is available. In addition, any applications that perform printing using the communication apparatus 151 can be expected to operate in the same manner and produce the same results whether the operating environment is the first environment or the second environment as long as the selected communication apparatus 151 can be used by the communication application 300. In this way, each application may be classified in advance based on whether its operation differs between the first environment and the second environment, and the determination may be based on the classification. In this case, information indicating whether or not the operating environment needs to be determined for each application may be registered in advance in the communication application 300, and the determination in step S701 may be performed based on that information.

If it is determined in step S701 that the operating environment needs to be determined, it is determined whether the current operating environment is the first environment or the second environment (S702). If it is determined in step S702 that the operating environment is the second environment, the CPU 103 sets the icon of the target application to be “hidden” (step S703). The setting is stored in a memory such as the RAM 105. “Hidden” only means that the icon is not operable, and the icon may be displayed in a manner indicating that the icon is not operable. On the other hand, if it is determined in step S702 that the operating environment is the first environment, or if it is determined in step S701 that the operation of the target application does not differ between the first and second environments, processing branches to step S704.

The CPU 103 determines whether or not the resources used by the target application are sufficient (S704). If the resources are sufficient, the CPU 103 sets the icon of the target application to be “displayed” (step S705). The setting is stored in a memory such as the RAM 105. On the other hand, if the resources are insufficient, processing branches to step S703. The resources may be resources of the information processing apparatus 101 or resources external to the information processing apparatus 101, such as resources of the communication apparatus 151. For example, the image capturing apparatus 111 may be subject to the determination. Some applications use an image capturing apparatus provided on the back of the information processing apparatus 101, and for such applications, the resources are insufficient if there is no image capturing apparatus on the back, even if there is an image capturing apparatus on the front. In any case, the resources whose presence or absence can be determined by the communication application 300 are the subject of the determination. The determination in step S704 may be performed by, for example, referencing resources required for each application and determining whether or not all of the resources are available to the information processing apparatus 101. The resources required for each application can be identified from each application, but may be prepared separately.

In the present embodiment, with the above configuration and procedures, it is possible to prevent an Android app that does not operate as it does in the actual environment (the first environment) in which the Android OS operates, in the virtual environment (the second environment) in which a virtual Android OS operates on the Chrome OS. Such prevention is accomplished by changing the way that application icons or buttons are displayed. The icons are displayed in an inoperable state or are not displayed so that the applications corresponding to the icons cannot be started up. In particular, for applications such as a browser that opens new windows when operate in the second environment, even if the screen in the first environment contains the icon for starting up the application, the screen in the second environment is displayed in a manner that prevents the icon from being operated, or is not displayed. An Android application is an application created for the first environment, i.e., in compliance with the Android OS, and to be executed on the Android OS.

For an application that opens a new window when operate in the second environment, even if the screen in the first environment contains an icon of a function that starts up the application, in the second environment, the screen is displayed such that the icon is inoperable, or the screen does not contain the icon. An example of such an application is a browser, and an example of a function that starts up the application is a cloud linkage function.

Furthermore, even when an icon for starting up an application created for the first environment is to be displayed, if the operation of the application differs between the first environment and the second environment, particularly if the application does not operate or does not function properly in the second environment, the icon will not be displayed. Thus, it is possible to prevent applications that do not function properly from starting up. Furthermore, for an application whose operation is the same between the first environment and the second environment, if an environment other than the OS, for example resources required by the application, is not provided, the icon of the application will not be displayed. Thus, it is possible to prevent applications that do not operate properly from being started up.

### Second Embodiment

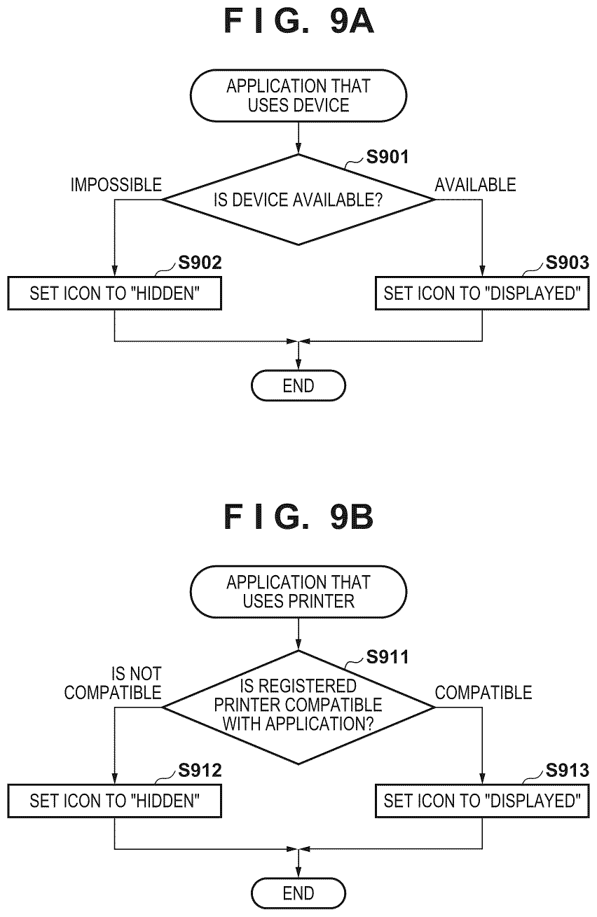

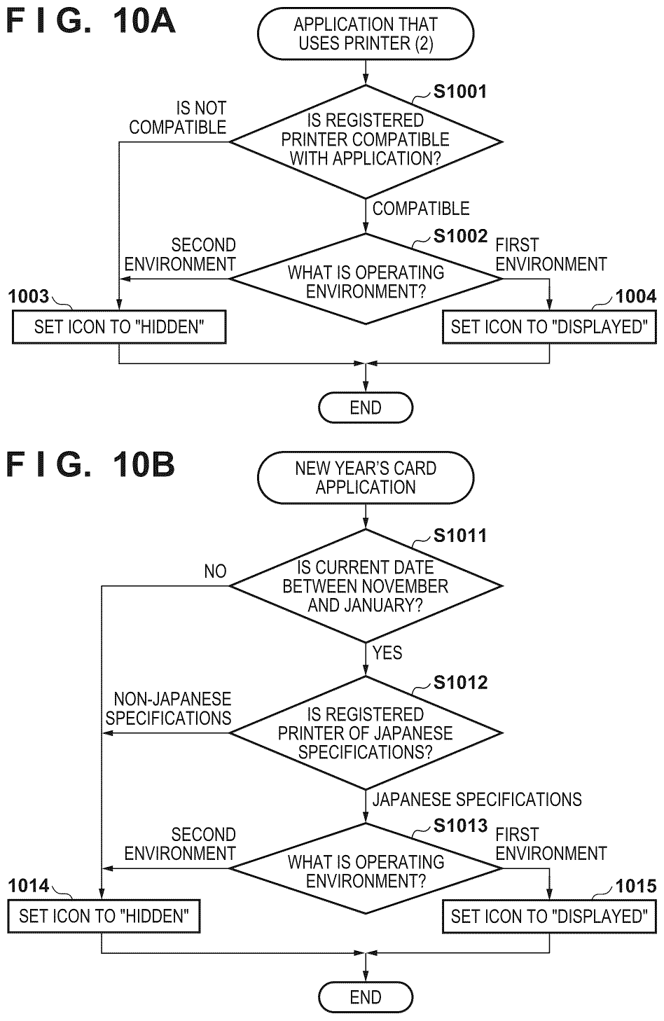

As described with reference to FIG. 7, the basis for the determination in step S701 may be what application is the target of the determination. In this case, in the determination in step S602 in FIG. 6, determination processing may be performed for each target application. In the second embodiment, exemplary processing procedures for displaying an icon for each application are shown in FIGS. 9A and 9B and 10A and 10B.

FIG. 9A shows an example of processing performed in step S602 for an application having a smartphone copy function, which is an example of an application that does not require determination regarding the operating environment. The smartphone copy function is the function of printing an image captured by the communication apparatus 151, using the information processing apparatus 101. Regarding a resource to be used, the CPU 103 determines whether or not a device (or function) of the information processing apparatus 101, specifically, the image capturing apparatus 111, is available (S901). Whether to display or hide the application icon is determined based on the result of the determination in step S901. If the device used by the application is available, the CPU 103 sets the icon to be “displayed” (S903), and if the device is unavailable, the CPU 103 sets the icon to be “hidden” (S902). In this way, for the smartphone copy function, which does not operate differently in the first and second environments and does not open a plurality of windows simultaneously, there is no need to determine the operating environment.

FIG. 9B shows yet another example. FIG. 9B shows an example of a determination procedure for an application that uses a print function of the communication apparatus 151 or the like and whose operation does not differ between the first environment and the second environment. Examples of such applications include a cloud application that prints photos provided by a cloud, and a copy application that prints a document scanned by the communication apparatus 151, using the communication apparatus 151 in response to an operation from the information processing apparatus 101. The CPU 103 determines whether or not the printing apparatus registered in the communication application 300 as a printer to be used, i.e. the communication apparatus 151, is compatible with the target application (S911). This determination may be performed by referencing capability information acquired from the communication apparatus 151, for example. In particular, the determination may be performed based on the model of printing apparatus involved. If it is compatible, the CPU 103 sets the icon to be “displayed” (S913), and if it is not compatible, the CPU 103 sets the icon to be “hidden” (S912). In this way, for a copy application and a cloud application, which do not operate differently in the first and second environments and do not open a plurality of windows simultaneously, there is also no need to determine the operating environment.

FIGS. 10A and 10B show yet other examples. FIG. 10A shows a procedure for determining whether or not to display an icon for an application for processing and printing a photo, or an application for editing and printing content such as an image held by communication application 300 in advance. Such an application is subject to determination not only with respect to compatibility with the communication apparatus 151 registered in the information processing apparatus 101 as a printer to be used, but also with respect to the operating environment in which the application is executed. The CPU 103 determines whether or not the registered printer, i.e. the communication apparatus 151, is compatible with the target application (S1001). This determination may be performed by referencing capability information acquired from the communication apparatus 151, for example. If it is compatible, the CPU 103 determines whether the current execution environment of the target application is the first environment or the second environment (S1002). If it is determined that the current execution environment is the first environment, the CPU 103 sets the icon to be “displayed” (S1004), and if the current execution environment is the second environment, the CPU 103 sets the icon to be “hidden” (S1003). If it is determined in step S1001 that the registered printer is not compatible with the target application, the CPU 103 also sets the icon to be “hidden” (S1003). If the resource used by the application is available and the execution environment is the first environment, the CPU 103 sets the icon to be “displayed” (S1004). In this case, the icon of the print application involving image processing is displayed in an operable state. As a result, the user can operate the icon of the application and execute the application.

FIG. 10B is a flowchart showing an example of a procedure for controlling whether to display or hide the icon of a so-called New Year's card application. The New Year's card application is a program that provides a design to be printed on a New Year's card, places the text entered along with the design on the back of the card, places the address acquired from an address book on the front, and prints them double-sided in postcard size. Therefore, the New Year's card application is an application for Japan that is usually used during the period in which New Year's cards are created. In FIG. 10B, these conditions are also taken into account when controlling whether to display or hide the application icon.

First, the CPU 103 determines whether the current date is November, December, or January (S1011). The periods used in this determination are examples of periods when New Year's cards are likely to be created and printed, and the range of periods may be narrowed or broadened. Next, the CPU 103 determines whether or not the registered printer, i.e. the communication apparatus 151, is of Japanese specifications (S1012). This determination may be performed by referencing capability information, e.g. its model, acquired from the communication apparatus 151, for example. That is to say, this processing is common to S1001 in which it is determined whether or not the registered printing apparatus is compatible with the New Year's card application, which is the target application. If it is compatible, i.e., if the printer is of Japanese specifications, the CPU 103 determines whether the current execution environment for the target application is the first environment or the second environment (S1013). If it is determined that the current execution environment is the first environment, the CPU 103 sets the icon to be “displayed” (S1015), and if the current execution environment is the second environment, the CPU 103 sets the icon to be “hidden” (S1014). If it is determined in step S1011 that the current date is between February and October, or if it is determined in step S1012 that the registered printer is not of Japanese specifications, the CPU 103 also sets the icon to be “hidden” (S1014). In this way, for the New Year's card application, if the date falls within a specific period, the printer is of Japanese specifications, and the execution environment is the first environment, the icon is displayed in an operable state. Thus, the icon of the application is displayed and the application can be executed when the predetermined conditions are satisfied. Conversely, if the predetermined conditions are not satisfied, the icon of the application is not displayed in an operable state, and therefore the New Year's card application cannot be executed.

For example, even if the period and printer specifications satisfies the conditions for the New Year's card application, if the execution environment is the second environment, which is a virtual Android OS environment, the New Year's card application cannot be executed. This is because, for example, user operations in the New Year's card application are performed step by step, with a new screen being displayed each time. Such an application may result in a plurality of windows being displayed simultaneously in the second environment, which may significantly impair operability and convenience. In the present embodiment, such a problem is avoided by allowing the New Year's card application to operate only in the first environment. Although the New Year's card application is described in this example, the procedure in FIG. 10B can be applied to any application executed at a particular time of year, not limited to the New Year's card application.

As described above, according to the second embodiment, when an icon used to start up another application from the communication application 300 is to be displayed, determination is performed for each individual application as to whether or not execution is permitted, and only if execution is permitted, the icon is displayed in an operable state. On the other hand, if execution is not permitted, the application is prevented from being executed by not displaying the icon of the application in an operable state. In the present embodiment, since the display of an icon is determined for each application, there may be other procedures for determining the individual applications in addition to the examples shown in FIGS. 9A and 9B and 10A and 10B.

Furthermore, the first and second embodiments describe controlling the display of icons contained in a screen in relation to when the communication application 300 is started up and a screen of a function corresponding to an icon selected by the user from the home screen is displayed. However, the subjects of control may be further extended, and icons displayed on the home screen of the communication application 300 may be subject to the same control as in the first and second embodiments. In this case, determination is performed as to whether or not the functions or applications corresponding to the icons displayed on the home screen can be executed, and the icons of functions or applications that cannot be executed are displayed in such a manner that the user cannot operate them, or are not displayed. Similarly, the display control according to the first and second embodiments may be applied not only to the communication application 300 but also to other applications that can be executed in the second environment.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-173860, filed Oct. 5, 2023 which is hereby incorporated by reference herein in its entirety.

What is claimed is:

1. A non-transitory computer-readable medium storing thereon a predetermined program operable on an operating system (OS), which when executed by one or more processors of a first information processing apparatus having a first operating environment on a first OS operating as a host OS but not on a guest OS, cause the first information processing apparatus to perform a first method, the first method comprising:
receiving a predetermined operation from a user; and
displaying a first screen containing a predetermined button for displaying a screen by using a program other than the predetermined program based on a fact that the predetermined program operates in the first operating environment and a fact that the predetermined program has received the predetermined operation,
wherein the program, which when executed by one or more processors of a second information processing apparatus having a second operating environment on a second OS operating as the host OS and on the guest OS, cause the second information processing apparatus to perform a second method, the second method comprising:
receiving the predetermined operation from a user; and
displaying a second screen not containing the predetermined button based on a fact that the predetermined program operates in the second operating environment and a fact that the predetermined program has received the predetermined operation.

2. The computer-readable medium according to claim 1,
wherein the host OS in the first operating environment is an Android OS, the host OS in the second operating environment is a Chrome OS, and the guest OS in the second environment is a virtual Android OS.

3. The computer-readable medium according to claim 1,
wherein the program causing the computer of the first information processing apparatus and the computer of the second information processing apparatus to
determine whether an operating environment in which the program is executed is the first operating environment or the second operating environment.

4. The computer-readable medium according to claim 1,
wherein the other program is a browser program.

5. The computer-readable medium according to claim 4,
wherein, in the computer of the first information processing apparatus, the browser program displays a screen used to select a cloud service when the predetermined button is operated on the first screen.

6. The computer-readable medium according to claim 5,
wherein the predetermined program causes the computer of the first information processing apparatus to print an image provided by the selected cloud service.

7. The computer-readable medium according to claim 1,
wherein the first screen displays one or more images held by the first information processing apparatus,
the predetermined program causes the computer of the first information processing apparatus to print an image selected on the first screen,
the second screen displays one or more images held by the second information processing apparatus, and
the predetermined program causes the computer of the second information processing apparatus to print an image selected on the second screen.

8. The computer-readable medium according to claim 1,
wherein the other program is a program provided by a vendor that provides the predetermined program.

9. The computer-readable medium according to claim 1,
wherein the first screen and the second screen contain a second button for displaying a screen by using a second other program that is different from the predetermined program and different from the other program.

10. The computer-readable medium according to claim 9,
wherein, in displaying the first screen, control is performed to determine whether or not to display on the first screen the second button for displaying a screen by using the second other program, based on a model of a printing apparatus registered in the predetermined program, and
in the displaying the second screen, control is performed to determine whether or not to display on the second screen the second button for displaying a screen by using the second other program, based on a model of a printing apparatus registered in the program.

11. The computer-readable medium according to claim 10,
wherein, control is performed to determine whether or not to display on the first screen the second button for displaying a screen by using the second other program, based on a function of the computer of the first information processing apparatus, and
control is performed to determine whether or not to display on the second screen the second button for displaying a screen by using the second other program, based on a function of the computer of the second information processing apparatus.

12. The computer-readable medium according to claim 9,
wherein, when a model of a printing apparatus registered in the predetermined program does not support a function corresponding to the second button, the second button is not displayed on the first screen, and when the model of the printing apparatus registered in the predetermined program supports the function corresponding to the second button, the second button is displayed on the first screen.

13. The computer-readable medium according to claim 1,
wherein the first operating environment is an operating environment in which a plurality of windows are not displayed simultaneously, and the second operating environment is an operating environment in which a plurality of windows can be displayed simultaneously.

14. The computer-readable medium according to claim 1,
wherein the other program is a program that involves passing data managed by an operating system to the program, and a format of the data differs between the first operating environment and the second operating environment.

15. The computer-readable medium according to claim 1,
wherein the other program is a program that is not compatible with the second operating environment.

16. The computer-readable medium according to claim 1,
wherein the second screen displayed in response to the predetermined operation does not contain the predetermined button or contains the predetermined button in an inoperable state.

17. The computer-readable medium according to claim 1,
wherein the predetermined program is an application program.

18. A control method for controlling a first information processing apparatus having a predetermined program operatable on an operating system (OS) and having a first operating environment on a first OS operating as a host OS but not on a guest OS, and a second information processing apparatus having the predetermined program and having a second operating environment on a second OS operating as the host OS and on the guest OS, the control method comprising:
in the first information processing apparatus, receiving a predetermined operation from a user by using the predetermined program;
in the first information processing apparatus, by using the predetermined program, displaying a first screen containing a predetermined button for displaying a screen by using a program other than the predetermined program based on a fact that the predetermined program operates in the first operating environment and a fact that the predetermined program has received the predetermined operation;
in the second information processing apparatus, receiving the predetermined operation from a user by using the predetermined program; and
in the second information processing apparatus, by using the predetermined program, displaying a second screen not containing the predetermined button based on a fact that the predetermined program operates in the second operating environment and a fact that the predetermined program has received the predetermined operation.
